(19) United States
(12) Patent Application Publication
(10) Pub. No.: US 2018/0309307 A1
(43) Pub. Date: Oct. 25, 2018

(54) LOW TEMPERATURE BATTERY SYSTEMS AND METHODS

(71) Applicant: Revision Military S.à.r.I., Luxembourg (LU)

(72) Inventor: Steve Carkner, Ottawa (CA)

(73) Assignee: Revision Military S.à.r.I., Luxembourg (LU)

(21) Appl. No.: 15/766,386

(22) PCT Filed: Oct. 7, 2016
(86) PCT No.: PCT/IB2016/001554

§ 371 Date: Apr. 6, 2018

Related U.S. Application Data
(60) Provisional application No. 62/238,649, filed on Oct. 7, 2015.

(51) Int. Cl. H02J 7/00; H01M 10/44

(52) U.S. Cl. CPC H02J 7/0029; H02J 7/0063; H02J 2007/0037; H02J 7/0047; H01M 10/44; H02J 7/007

(57) ABSTRACT

A power control system includes a power converter and a controller to lengthen operational time for devices powered by batteries in low temperature environments. When a battery provides reduced voltage to due to cold temperatures, yet still has sufficient energy stored within the battery, a power converter may be activated to boost the voltage such that a load can be operated. When the power converter is not needed, the delivery of power from the battery to the load may bypass the power converter. A controller may determine if the reduced voltage from the battery is due to temperature or low energy storage in some embodiments.

### FIELD OF THE INVENTION

This invention pertains to the field of batteries and power systems, and particularly to systems designed to be used in extreme cold environments where standard battery systems will not function properly.

### DISCUSSION OF THE RELATED ART

Battery systems, in particular rechargeable batteries, can suffer significant loss of capacity when they are operated at low temperatures, such as in an arctic environment. The loss of capacity is not due to reduced energy stored in the battery chemistry, but is due to the inability of the battery to convert the chemical potential energy into electrical energy at a rate that is suitable for the load applied. As a result, the output voltage of the battery may drop to a level that is unsuited to the equipment being powered and therefore trip any low-battery electronic detector systems that are included in the equipment or in the battery itself.

Battery systems have been developed for use in cold temperature environments. These battery systems modify the chemical nature of the energy storage in order to deliver energy, even when the battery is extremely cold. An example of such a method is to modify the commonly-used electrolytes of a rechargeable lithium ion battery, such as lithium hexafluorophosphate, with additives that improve the freezing point of the solution such that ionic mobility remains relatively free, even at very low temperatures. Alternatively, the electrolyte system can be replaced with an entirely new chemical composition that maintains conductivity at low temperatures.

Examples of low-temperature optimization of rechargeable battery chemistries can be found in publications such as Ein-Eli et al., “Li-Ion Battery Electrolyte Formulated for Low-Temperature Applications,” J. Electrochem. Soc., 144(3):823-9 (1997), or in a wide variety of patents and patent applications such as “Electrolyte suitable for use in a lithium ion cell or battery”, U.S. Pat. No. 8,758,946 B2, Robert McDonald.

The drawback of low-temperature optimized chemistry generally becomes apparent when safety testing such cells at room temperature or higher. These solutions often lack high temperature stability, have flammability problems, and may also impact the cycle life, calendar life, self-discharge rate, and a host of other application specific performance requirements for rechargeable battery systems. Specialized chemicals also contribute to much higher production costs, often an order of magnitude higher than conventional standard-chemistry batteries.

Other approaches to low temperature battery operation include methods that must predict usage requirements. For example, heater systems that can be intrinsically combined with the battery, or added to the battery as an accessory, must be activated prior to applying a large load to the battery. In remote applications, the batteries may be required to power their own heaters, resulting in a situation where the batteries do not have a high enough rate of energy delivery to run the heating system that would allow the batteries to increase their rate of energy delivery.

### SUMMARY

According to one embodiment, a power control system includes a power converter and a controller. The controller includes a first input to receive a battery temperature value of a battery, and a second input to receive a load voltage requirement value. The controller determines whether the battery can support the load voltage requirement without intervention, the determination being based at least in part on the battery temperature value and the load voltage requirement value. The controller also has an output configured to activate the power converter when the controller determines that the battery cannot support the load voltage requirement without intervention.

According to another embodiment, a power control system includes a power converter configured to receive electrical power from a battery via a first electrical connection, and a controller. The controller includes a first input to receive a battery voltage value, and a second input to receive a load voltage requirement value. The controller also includes an output configured to activate the power converter when the battery voltage value falls below the load voltage requirement value. When the power converter is activated, electrical power is permitted to travel from the battery to a load through the power converter. When the power converter is not activated, electrical power is not permitted to travel through the power converter to the load, and instead travels from the battery to the load via an electrical connection that bypasses the power converter.

According to a further embodiment, a method of controlling a power system includes: (a) measuring an output voltage of a battery; (b) determining a minimum load voltage requirement of a load electrically connected to the battery; and (c) measuring a temperature of the battery. The method further includes: (d) based on at least the output voltage of the battery, the minimum load voltage requirement, and the battery temperature, using a controller to determine whether the battery contains sufficient energy to supply electric power to the load if a power converter is used to increase a voltage of the electric power to the minimum load voltage requirement. The method also includes: (e) if it is determined that the battery contains sufficient energy to supply electric power to the load if a power converter is used to increase a voltage of the electric power to the minimum load voltage requirement, activating the power converter.

According to yet another embodiment, a power control system monitors battery temperature, load voltage, and cell voltage. The power control system includes a power converter and a battery, wherein said power control system is configured to enable or disable the power converter based on battery temperature, and wherein the power converter is enabled when the battery temperature is cold, and is configured to increase an output voltage of the battery.

### DESCRIPTION OF THE FIGURES

FIG. 1 shows a block diagram of one embodiment of a battery system;

FIG. 2 shows a graph of the performance of one embodiment of a battery system and a load at very low temperature; and

FIG. 3 shows a flow chart of a control system algorithm according to one embodiment of the present invention.

### DETAILED DESCRIPTION

There remains a need for a system to improve the way batteries operate in a cold environment that may be independent of the battery chemistry and may be made instantly available, without a requirement to use heaters or to move the battery to a warmer location. The system may be able to maintain a level of power flow to a connected load that is compatible with the load, and that does not cause the connected load to enter a low-battery shutdown mode.

Disclosed herein is a power system that recognizes the energy demand of a load, anticipates the need for intervention in the power path due to the temperature of the system and is able to modify the operating parameters of the system, in order to maintain the load within a desired operating range.

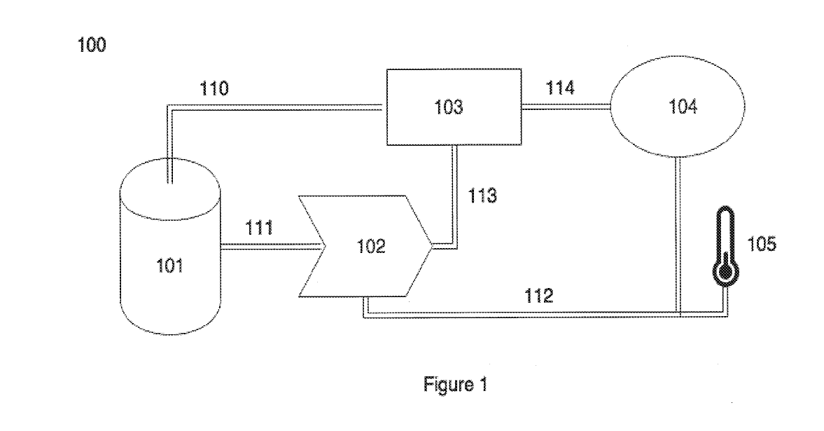

Referring to FIG. 1, a block diagram of the arctic operation battery is shown 100 connected to a representative load 104. The electrochemical battery cells 101 may be rechargeable lithium cells or they may be based on another chemistry and may be rechargeable or disposable in nature.

If the load 104 were connected directly to the cells 101 and subjected to very cold temperatures, the operational time of the system would be quite low, and possibly would not function at all. At cold temperatures the ion mobility of the battery system becomes slow and therefore the output voltage of the cells will drop under load. The magnitude of the drop is proportional to the load applied. If the load 104 includes circuitry that detects a low battery voltage, then the load itself may switch off due to the voltage drop at the output of the cells in order to protect the load or because the load is unable to operate.

If the cells are of a type that requires a battery management system, the battery management system may detect that the cell voltage has fallen and then may disconnect the load.

In either case, a load 104 connected directly to the cells 101 at low temperatures will experience a decrease in operational run-time, even though the cells do contain chemical energy potential.

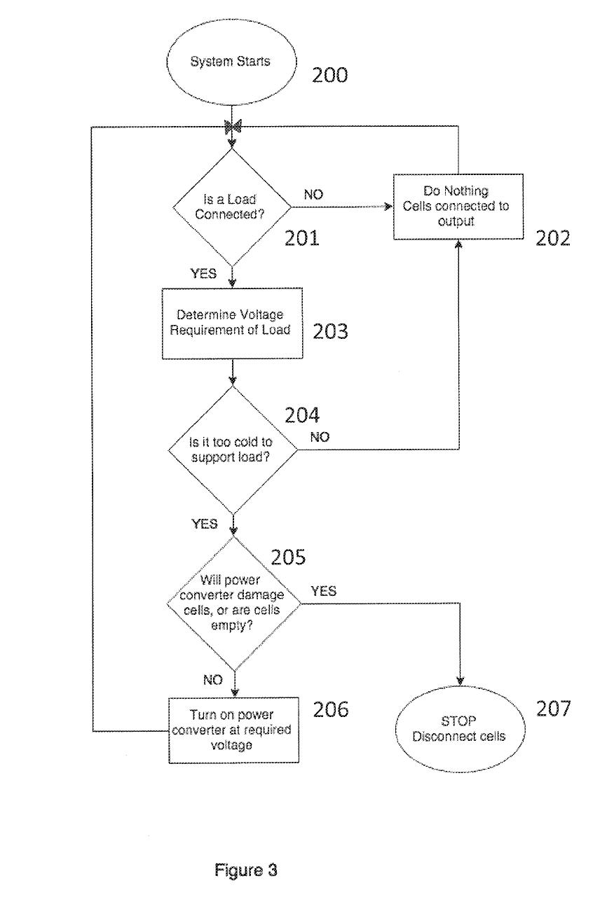

Embodiments disclosed herein include a power control system 102, a power converter 103, and a temperature sensor 105 which together allow the operational range of the battery system to be improved, in some cases dramatically. The power control system 102 senses the requirements of the load 104, through an electrical connection 112 and may include digital, analog or wireless signals which carry information primarily related to voltage, current and temperature, but may also include other parameters that are typically found in battery monitoring systems such as power, fault status, impedance and health. The power control system 102 also may receive the ambient temperature via the temperature sensor 105. The power control system 102 also may monitor the battery cells 101 through an electrical connection 111 to determine, among other parameters, whether the battery as a whole can support the load requirements without intervention, or whether intervention is required to support the load. A flow-chart for the power control system is included in FIG. 3, and is described further below.

If intervention is required, the power control system 102 activates the power converter 103 through an electrical connection 113 with settings that are: appropriate for the load 104; appropriate for the temperature 105; and safe for the cells 101. The power converter 103 then draws power from the cells 101 through an electrical connection 110 and delivers the power to the load 104 through another electrical connection 114.

For example, if the load 104 requires a minimum voltage of 12 volts to operate, and the battery contains four series cells 101 based on a nominal 3.6V lithium chemistry, then the operating voltage at room temperature would be 14.4V. The power control system may detect that the temperature range is in a normal range and would therefore disable, bypass or otherwise inhibit intervention by the power converter as intervention is not necessary for normal operation.

At cold temperatures and a high load power, if the cells drop to less than 3.0V, the load may cease operating. In order to avoid this situation and maintain the voltage level, if the power control system 102 detects a cold operating environment through the temperature sensor 105, and detects that the load 104 requires significantly higher voltage levels than the cells 101 can deliver at the temperature, then the power control system 102 can activate the power converter 103 to boost the voltage from the cells 101 to a level that is suitable for operating the load 104.

The cells 101 in this example may have ratings from the manufacturer that include maximum and minimum operating voltages. For example, the cells may be rated for operation at voltages of no less than 2.75 volts. However, at cold temperatures, many cells can be operated to much lower voltages, even down to zero volts, without damage. The lowest allowable operating voltage for a given arrangement may be determined via testing.

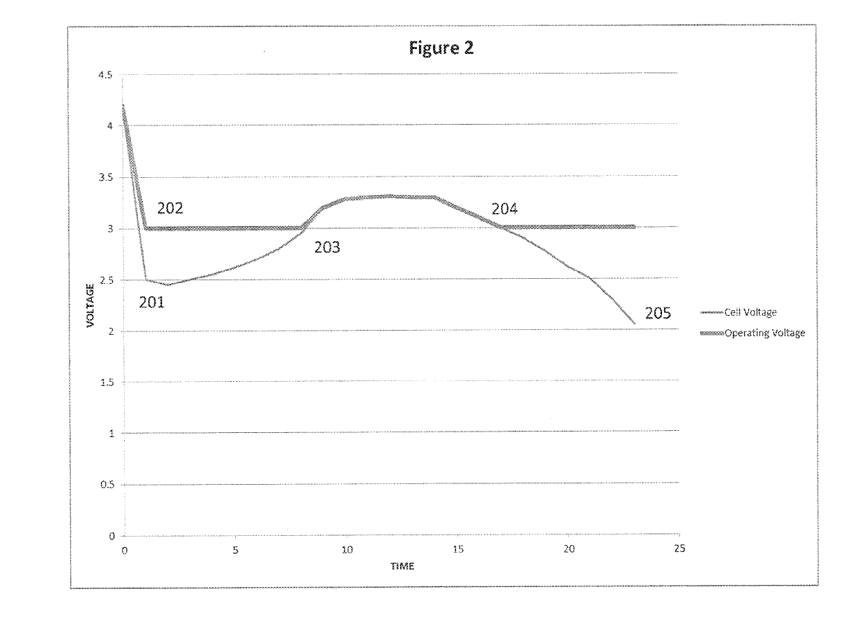

As a further example, referring to FIG. 2, the chart shows voltage on the vertical axis and time on the horizontal axis. The thin line is the voltage of a single lithium ion cell that has been fully charged to 4.2 volts. The thick line represents the voltage seen by the load when used with one embodiment of systems discloses herein.

At time zero, the load is switched off, and is therefore not using any power, and the cell voltage remains at 4.2 volts. Referring to FIG. 3, at a step 200 the system performs the “System Starts” step and a detection step 201. If the system detects no load, at step 202 the circuitry does nothing to the cell voltage and simply connects the cell directly to the output and waits for a load to be connected. When the load is enabled, in this example, the voltage of the cell quickly drops to about 2.5 volts 201 due to the cold operating temperature. The power control system detects the increased load and low temperature and sets the power conversion system to maintain an output voltage of 3.0 volts which is applied to the load. With further reference to FIG. 3, the system detects that a load has been connected, and at step 203 it then determined that the voltage requirement of the load is 3.0 volts minimum (such detection could be done with a special cable, digital control signal, communication with the equipment, a resistor setting, or a number of other methods well understood in the industry). At step 204 the system further determines if it is too cold to support the required load at the temperature sensed while maintaining the minimum output voltage. In some embodiments, this determination is performed based on mathematical formulas related to the impedance of the battery under specific temperature conditions. In some embodiments, this determination is based on lab-testing of the cells. In some embodiments, this determination is made in real time using voltage sensing circuits that detect the falling voltage and provide information to the control system that an under-voltage condition is imminent.

At a step 205 in the flow chart of FIG. 3, it is determined whether the voltage converter circuit can be enabled without damaging the cells. A system which drives the cells toward zero voltage by overloading them could result in damage to the cells. For example, drives the cells toward zero voltage could create an unsafe condition in battery packs that are composed of multiple cells because stronger cells may overpower weaker cells, resulting in reverse-polarity, pressure build up, and possible rupture. Accordingly, the system may be configured to evaluate the operating conditions to determine if the load can be supported in view of various factors, including potential damage to the cells. If it is determined that it is safe to proceed, the system activates the power converter at a step 206. As may be seen in FIG. 2, the operating voltage, shown as a thick line, falls to 3.0 volts (202) and then stabilizes due to the power converter.

Over time the voltage at the cell may rise. The increased voltage may occur due to self-heating inside the battery, and/or may occur due to the waste heat generated by the load and the electronics within the battery pack. After some time, the voltage may reach 3.0 volts (203) at which point the power control system may disable the power converter and/or bypass the power conversion circuitry. The system may continually monitor the output voltage of each cell and disengage the power conversion circuitry in some embodiments. The self-heating of the cells coupled with the rising voltage, may allow the “is it too cold to support the load” decision step 204 to be “No” which allows the power converter to be disengaged and the cell voltage to be fed to the load directly. This causes the voltage at the load to be approximately equal (within given wiring, electronics and connection losses) to the voltage at the cell.

Eventually the voltage on the cell will stabilize and then begin to drop again as the cell energy becomes exhausted. The amount of time this takes is dependent on the magnitude of the load and the storage capacity of the cell. Once the voltage of the cell falls below the operating level of the load, the power conversion circuitry is again engaged and enables the power conversion circuitry to maintain a 3.0 volt level (204).

Eventually the cell will be fully or almost fully discharged and will reach a level at which damage could occur. In response, the power control system may be configured to cause the system to shut down either through disconnection or by sending a message to the load that the battery is exhausted. The voltage at which this response occurs may be dependent on the application, the load and the chemistry involved. Referring to the flow chart of FIG. 3, when the answer to the question of “Will power converter damage cells, or are cells empty” (step 207) is “Yes”, the cells will be disconnected from the load. Battery recharge may be performed to bring the cells back to a storage level that permits functioning.

If the arctic operation mode was not used in this particular example, the load would not have operated beyond the first few seconds because the voltage drop experienced by the cell would have triggered the low-voltage shutdown of the load. It can therefore be seen that the arctic operation system may be able to dramatically increased the operational time of the load without changing the fundamental chemistry of the cells used.

Actual testing of this system utilizing a radio transmitter system connected to a lithium rechargeable battery showed a 30% increase in operational time at a temperature of −20° C. In a more extreme temperature example, an amount of operational time was achieved at −40° C., whereas without the power conversion system, the load would not function for any amount of time.

The temperature sensor itself may be located in the load, in the ambient environment, in the battery cells or may be part of the power control system. Multiple temperature sensors may be present in two or more of these components, and the temperature may be a mathematical or statistical combination of multiple temperatures.

The power control system may include a battery management system for providing additional safety and management features such as over voltage, over current, capacity and health monitoring.

The power control system 102 may be any suitable control system, including a controller comprising a microprocessor or other suitable processor.

For purposes herein, measuring a value, such as measuring a battery temperature or a load voltage requirement, is intended to be construed broadly to include, but not be limited to, receiving a measured value, receiving an estimated value, receiving an indication that a value falls within a certain range, directly measuring a value with a measuring instrument, and/or detecting a value either directly or via an intermediate component.

Alternatively, the power control system may be a controller which is comprised entirely of software that is used in conjunction with existing power conversion, battery management and load management systems to improve functionality of the entire system during cold exposure.

Although the description above contains much specificity, these should not be construed as limiting the scope of the invention but as merely providing illustrations of the presently preferred embodiment of this invention. Thus the scope of the invention should be determined by the appended claims and their legal equivalents.

What is claimed is:

1. A power control system comprising:
a power converter; and
a controller including:
a first input to receive a battery temperature value of a battery;
a second input to receive a value of a load's voltage requirement;
wherein the controller determines whether internal cells of the battery can support the load's voltage requirement without intervention, the determination being based at least in part on the battery temperature value and the load voltage requirement value; and
an output configured to activate the power converter when the controller determines that the internal cells of the battery cannot support the load's voltage requirement without intervention.

2. A power control system as in claim 1, wherein the controller includes a third input to receive a battery cell voltage value, and the determination of whether the internal cells of the battery can support the load's voltage requirement without intervention is based at least in part on the battery cell voltage value.

3. A power control system as in claim 1, further comprising a thermometer to acquire the battery temperature value.

4. A power control system as in claim 1, further comprising the battery cells.

5. A power control system as in claim 1, wherein the power converter is configured to increase the voltage of electric power.

6. A power control system as in claim 5, wherein the power converter is configured to increase the voltage of electric power by an adjustable amount.

7. A power control system as in claim 1, further comprising electrical connections arranged to connect the battery to the load, the electrical connections being configured such that when the power converter is not activated, the electrical connections bypass the power converter.

8. A power control system as in claim 1, wherein the controller determines whether the power converter can be activated without damaging the battery.

9. A power control system as in claim 1, wherein the second input is configured to receive a load's voltage requirement value as a value selected from a list.

10. A power control system comprising:
a power converter configured to receive electrical power from a battery via a first electrical connection; and
a controller including:
a first input to receive a battery voltage value;
a second input to receive a load's voltage requirement value; and
an output configured to activate the power converter when the battery voltage value falls below the load's voltage requirement value;
wherein when the power converter is activated, electrical power is permitted to travel from the battery to a load through the power converter; and
when the power converter is not activated, electrical power is not permitted to travel through the power converter to the load, and instead travels from the battery to the load via an electrical connection that bypasses the power converter.

11. A power control system as in claim 10, wherein the controller includes a third input to receive a battery temperature value of the battery, and the controller is configured to determine whether to activate the power converter based at least in part on the battery temperature value.

12. A power control system as in claim 11, wherein the controller is configured to determine whether to activate the power converter based at least in part on the battery voltage value.

13. A power control system as in claim 11, wherein the controller is configured to determine whether to activate the power converter based at least in part on the load voltage requirement value.

14. A power control system as in claim 12, wherein the controller is configured to determine whether the power converter can be activated without damaging internal cells of the battery.

15. A power control system as in claim 10, further comprising the battery.

16. A method of controlling a power system, the method comprising:
(a) measuring an output voltage of a battery;
(b) determining a load's minimum voltage requirement of a load electrically connected to the battery;
(c) measuring a temperature of the battery;
(d) based on at least the output voltage of the battery, the load's minimum voltage requirement, and the battery temperature, using a controller to determine whether the battery contains sufficient energy to supply electric power to the load if a power converter is used to increase a voltage of the electric power to the load's minimum voltage requirement; and
(e) if it is determined that the battery contains sufficient energy to supply electric power to the load if a power converter is used to increase a voltage of the electric power to the load's minimum voltage requirement, activating the power converter.

17. A method of controlling a power system as in claim 16, wherein (d) comprises measuring the output voltage of the battery over time to detect a falling voltage condition.

18. A method of controlling a power system as in claim 16, wherein (d) comprises referring to a look-up table relating battery temperature conditions and output voltage to stored energy.

19. A method of controlling a power system as in claim 16, wherein (d) comprises considering impedance of the battery under specific temperature conditions.

20. A method of controlling a power system as in claim 15, further comprising:
prior to (e), (f) determining whether the power converter can be activated without damaging the battery.
